(19) United States
(12) Patent Application Publication
(10) Pub. No.: US 2014/0208575 A1
(43) Pub. Date: Jul. 31, 2014

(54) TIE ROD SUPPORT FOR HYDRAULIC HAMMER

(71) Applicant: CATERPILLAR INC., Peoria, IL (US)

(72) Inventors: Rakesh D. Jagdale, Waco, TX (US); Francis Eric Fortner, Woodway, TX (US); Stephen Amborski, China Spring, TX (US); Dimitar Dostinov, Fort Worth, TX (US)

(73) Assignee: CATERPILLAR INC., Peoria, IL (US)

(21) Appl. No.: 13/751,975

(22) Filed: Jan. 28, 2013

(51) Int. Cl. F16B 41/00; E02F 5/30

(52) U.S. Cl. CPC F16B 41/002; E02F 5/305
USPC 29/525.02; 411/103

(57) ABSTRACT

A hydraulic hammer may include a power cell adapted to reciprocally drive a piston along an axis. The piston may, in turn, drive a hammer tool. A power cell and housing may be axially secured together by a plurality of tie rods and nuts secured to ends of the tie rods, and the housing may include open-sided pockets for accommodating the nuts. Each pocket may include a cavity that accommodates an extension of the tie rod or a specially formed nut to minimize movement of the nut in the direction of the pocket opening and thereby minimize bending of the tie rod. Engaging the back of the nut with the inside of the nut pocket further reduces the opportunity for the nut to rotate in the nut pocket as a result of force applied to the nut by the tie rod.

### TECHNICAL FIELD

This disclosure relates to design improvements for optimizing longevity and/or reducing the maintenance and/or replacement of parts in hydraulic hammers subjected to harsh cyclic stresses. More particularly, the disclosure relates to an improved nut pocket configuration for the front heads of hydraulic hammers affixed to and utilized on machines.

### BACKGROUND

Hydraulic hammers are generally employed on worksites to demolish and break up hard objects, including rocks, concrete, asphalt, and frozen ground. The hammers may be mounted to machines, such as excavators and backhoes, for example. The hammers may alternatively be powered by pneumatic pressure sources, as opposed to only hydraulic sources. In either event, a high-pressure fluid may be utilized within the hammer to cyclically drive a piston to strike a work tool, which in turn may carry an impulse wave to the object of demolition for breaking that object into smaller pieces, generally for easier removal from a worksite.

The high impact and repetitive nature of operating a hydraulic hammer is hard on its component parts which may suffer stresses resulting in bending or breaking. Repairing these components can be difficult and time consuming, particularly when components are bent or are forced out of alignment. Against this history, it may be beneficial to provide a hydraulic hammer that better accommodates cyclic stress loads, as particularly applied to parts employed in the hammer

### SUMMARY OF THE DISCLOSURE

In one aspect, a powered hammer assembly includes a front head having nut pockets, each nut pocket including a cavity, a tie rod nut inserted into a respective nut pocket in a first direction, and a tie rod inserted into the front head and mechanically coupled to the tie rod nut. The assembly may also include a structure mechanically coupled to the tie rod that engages the cavity and opposes motion in a direction opposite the first direction.

In another aspect, a method of operating a hydraulic hammer may include providing a front head having a nut pocket, the nut pocket having a side opening, where a top of the nut pocket is coupled to a tie rod bore and a bottom of the nut pocket has a cavity. The method may also include inserting a tie rod nut into the nut pocket, capturing a tie rod via the tie rod nut and inserting a structure mechanically coupled to the tie rod into the cavity.

In yet another aspect, a mounting structure for a head of a powered hammer may include a front head having four rectangular side faces, four nut pockets, one nut pocket formed at each edge joining the four rectangular side faces and four tie rod bores, one tie rod bore provided from a top of the front head to each nut pocket. Each nut pocket may include a cavity formed at a bottom of each nut pocket, with each cavity opposite the respective tie rod bore in each of the four nut pockets. The mounting structure may also include a plurality of tie rod nuts, one each inserted into each of the four nut pockets, a plurality of tie rods, one each inserted into a respective one of the four tie rod bores, each tie rod mechanically attached to a respective tie rod nut and a structure mechanically coupled to the tie rod that engages the cavity and opposes motion normal to a longitudinal axis of the tie rod.

### BRIEF DESCRIPTION OF THE DRAWINGS

FIG. 1 is a perspective view of an excavating machine that may incorporate the disclosed hydraulic hammer;

FIG. 2 is a perspective view of one exemplary embodiment of the disclosed hydraulic hammer;

FIG. 3 is a perspective view disclosing certain interior parts of the hydraulic hammer of FIG. 2;

FIG. 4 is a cutaway view of a front head of a hydraulic hammer with tie rod and tie rod nut;

FIG. 5 is a perspective view of a front head of the hydraulic hammer;

FIG. 6 is a cutaway view of the front head of FIG. 5;

FIG. 7 is a cutaway view of the front head with a tie rod and tie rod nut installed;

FIG. 8 is a cutaway view of the front head with a tie rod and tie rod nut showing alternative counterforce provision;

FIG. 9 is an alternate embodiment of the front head;

FIG. 10 is a cutaway view of the embodiment of the front head of FIG. 9;

FIG. 11 is an alternate embodiment of a tie rod nut for use with the front head of FIG. 9;

FIG. 12 is a cutaway view of the embodiment of the front head of FIG. 9 showing the tie rod nut of FIG. 11 and a tie rod; and

FIG. 13 is a method of using a front head assembly in a hydraulic hammer

### DETAILED DESCRIPTION

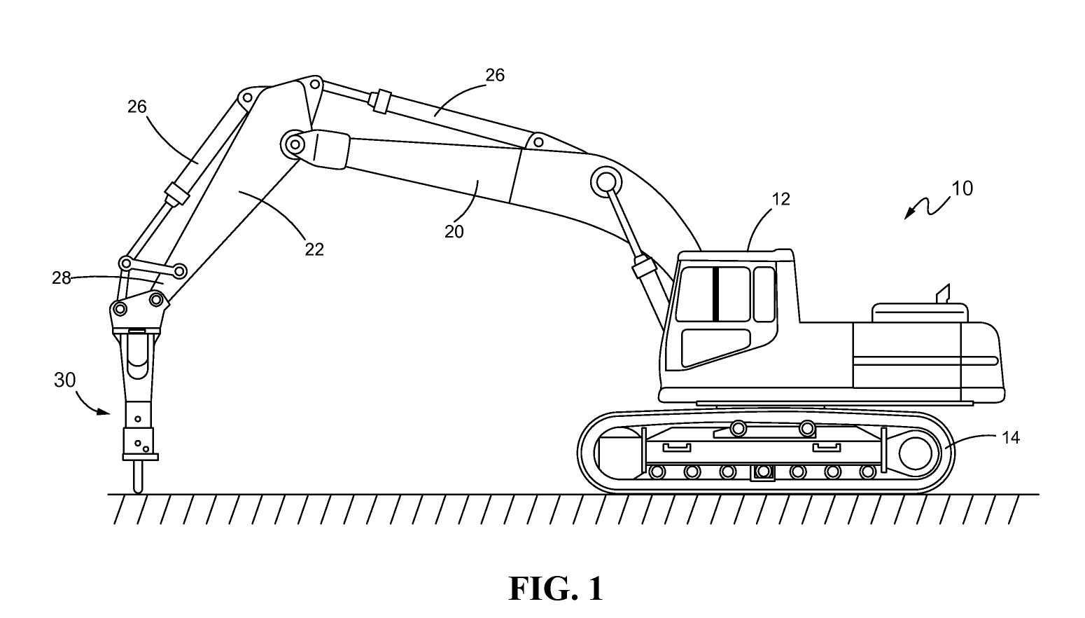

Referring initially to FIG. 1, an excavating machine 10 of a type used for digging and removing rock and soil from a construction worksite is shown. The excavating machine 10 may incorporate a cab body 12 containing an operator station, an engine, and operating controls (not depicted). The machine 10 may be supported by, and may move on, tracks 14. An extensible boom 20 may be movably anchored to the cab body 12, and an articulating stick 22, also variously called a lift arm, may be secured to and supported for movement on the boom 20.

The excavating machine 10 may incorporate a hydraulic hammer 30 as depicted, or may alternatively incorporate another implement, at an operational end 28 of the stick 22. Hydraulic cylinder actuators 26 may be utilized to move the stick 22 relative to the boom 20, and to move hydraulic hammer 30 relative to the stick 22.

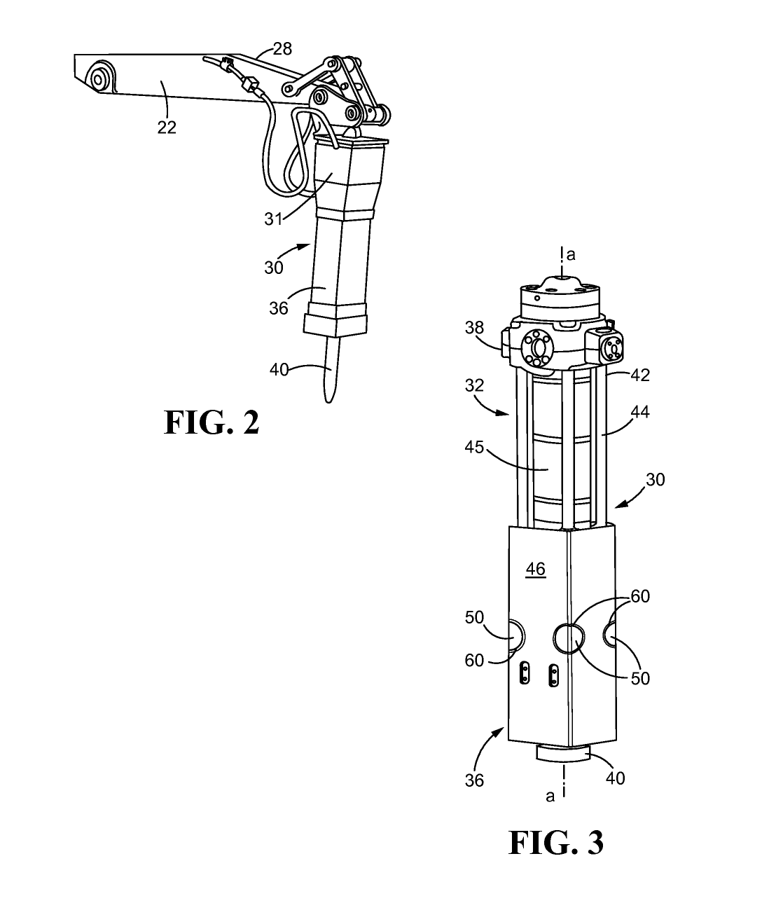

Referring now also to FIG. 2, a fluid powered hammer assembly, although herein called a hydraulic hammer assembly 30 may be secured to the operational end 28 of the stick 22. The hydraulic hammer assembly 30 may include an upper portion 31 that includes a power cell 32 shown below in FIG. 3 and a lower so-called front head portion 36 secured to the power cell 32. A hammer tool 40 having an upper end (not shown) may be retained within the front head portion 36. The hammer tool 40 may be adapted to produce cyclic vibrational movement at an intensity sufficient to demolish rocks, for example. The functional parts of the hydraulic hammer assembly 30, including the hammer tool 40 may be constructed of a forged or otherwise hardened metal such as a refined steel, for example, to assure appropriate strength, although other suitable materials such as diamond bits for operative portions of the hammer tool 40, for example, may be utilized within the scope of this disclosure.

Referring now also to FIG. 3, the hydraulic hammer assembly 30 is shown alone, i.e. detached from the stick 22 and with its exterior case covers removed, to reveal an exposed power cell 32, and a plurality of tie rods 44 circumferentially disposed about a cylindrical piston-containing sleeve structure 45. The sleeve structure 45 may contain a piston (not shown) adapted to drive the hammer tool 40. As such, the power cell 32 may be effective to utilize a suitable working fluid, such as a hydraulic and/or pneumatic fluid, for example, to reciprocally impact the piston against the upper end (not shown) of the hammer tool 40. It may also be appreciated that the plurality of tie rods 44 may be effective to retain or hold the power cell 32 and the front head portion 36 together under harsh impact loads as may be experienced within the hydraulic hammer assembly 30.

The lower front head portion 36 may define an actual front head 46, which may function as a structural housing to support the upper end (not shown) of the hammer tool 40 (shown only fragmentarily in FIG. 3). An upper end 42 of each of the tie rods 44 may be secured to an upper structure 38 of the power cell 32. Each tie rod 44 may have a threaded lower end (not depicted) that extends downwardly through a vertically oriented aperture or tie rod bore 48 within the front head 46. The tie rod bore 48 defines a longitudinal axis of the installed tie rod 44. Each tie rod 44 may be adapted to be threadedly secured to a tie rod nut 50.

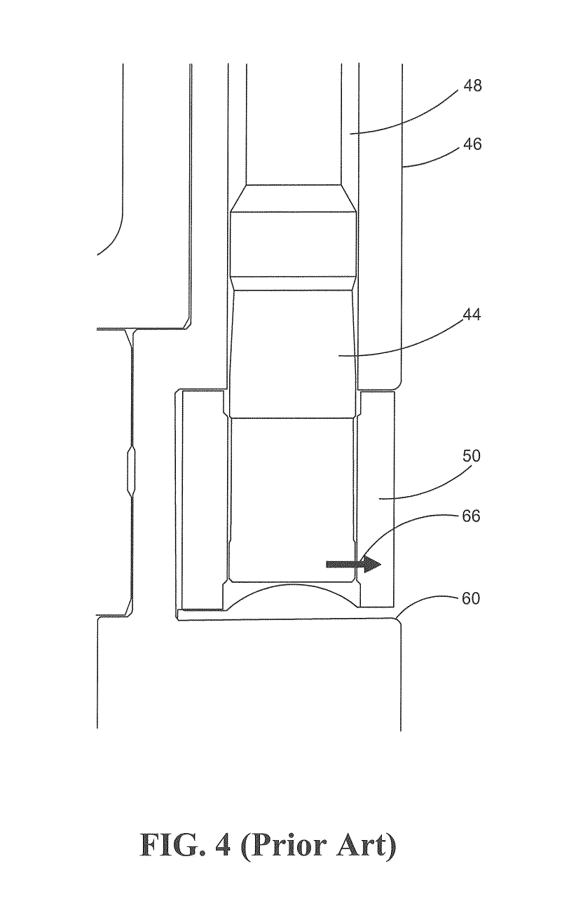

FIG. 4 is a cutaway view of a prior art front head 46 showing a tie rod 44 and a tie rod nut 50. It may be appreciated that each tie rod nut pocket 60 may be correspondingly positioned within each corner of the front head 46 to accommodate one tie rod nut 50. In the disclosed embodiment, one of four nuts 50 may be secured within one of four corresponding tie rod nut pockets 60. Each tie rod nut 50, though having a circular circumference may actually be pie-shaped when viewed along other orientations (not included herein). The shape of the nut pocket 60 in the planar frontal view may be elliptical or oval, and the actual size of the nut pocket 60 relative to a corresponding tie rod nut 50 has been somewhat exaggerated for clarity purposes.

During assembly, the tie rod 44 is inserted into the tie rod nut 50 and as the tie rod is tightened, the tie rod nut 50 is pulled up against the roof of the nut pocket 60. However, the contact area of the tie rod nut 50 at the front of the nut pocket 60 is smaller than the contact area of the nut 50 at the back of the pocket due to the placement of the nut pockets at the corners of the front head 46. Further, because the front of the nut pocket 60 is open, the top of the nut pocket 60 lacks the support at the front that it has at the closed structure of the back. This relative imbalance of support surfaces and the corresponding differences in front-to-back stiffness combined with the unsupported on the exterior side of the nut 50, can both deform the nut pocket 50 and allow the nut 50 to rotate in the nut pocket 60 when the tie rod nut 50 is pulled up by the tie rod 44. Over time, this rotation can bend the tie rod 44 and/or bend the tie rod nut 50 in the nut pocket 60. Even a slight rotation in the tie rod nut 50 and therefore the tie rod 44 can shift the stress loads in the tie rod 44 and reduce its load carrying capability. This rotation is illustrated by the arrow 66 showing exemplary movement of the bottom of the tie rod nut 50 toward the opening in the nut pocket 60. In practice, the top of the nut may also move toward the center of the front head 36.

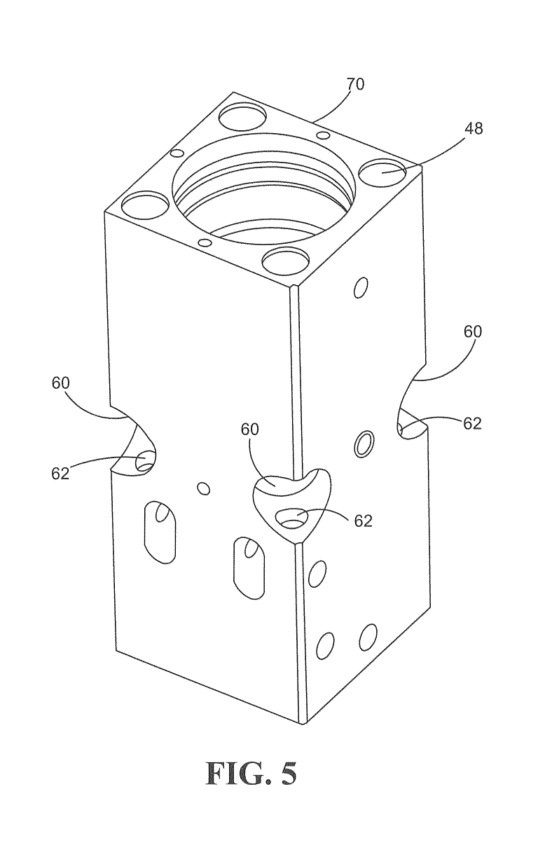

FIG. 5 is a perspective view of a front head 70. The front head 70 has a nut pocket 60 at each corner of the front head 46. A cavity 62 in the form of a disk-shaped recess may be formed at the bottom of each nut pocket 60. The cavity 62 is discussed in more detail below.

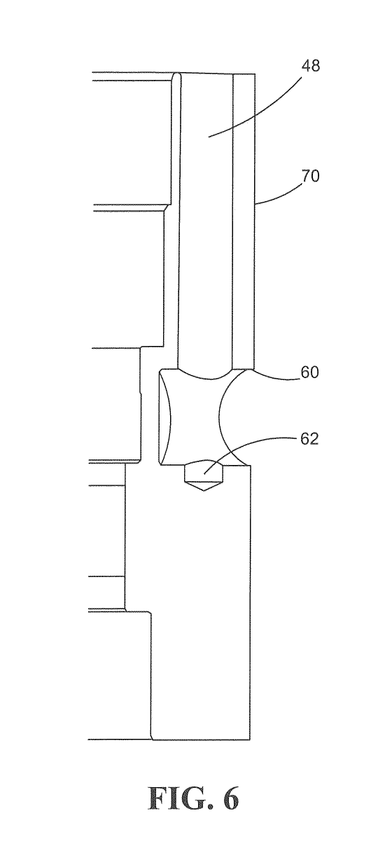

FIG. 6 is a cutaway view of the front head 70 of FIG. 5 showing the nut pocket 60 and the cavity 62. In the embodiment of FIGS. 5 and 6, the cavity 62 has a conical bottom. In other embodiments, the cavity 62 may have a flat bottom or the bottom may have another shape.

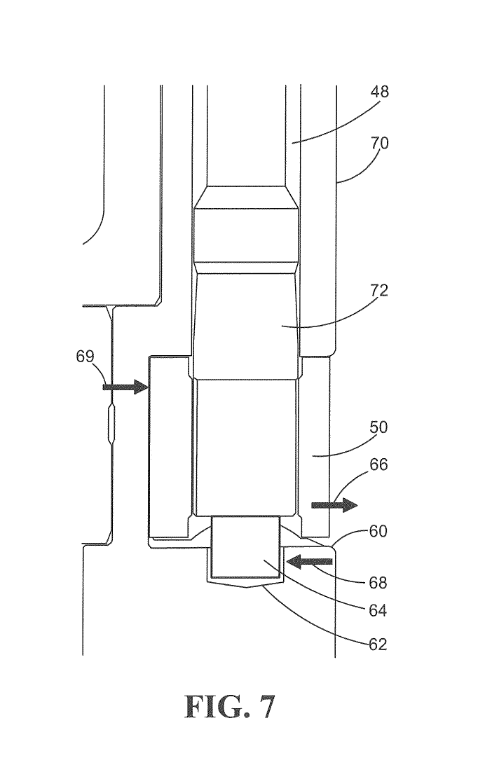

FIG. 7 is a cutaway view of the front head 70 with a tie rod 72 and tie rod nut 50 installed. The tie rod nut 50 may be placed in the pocket 60 and the tie rod 72 may be threaded onto the tie rod nut 50 via mating threads (not depicted). The tie rod 72 may have an extension 64 that extends into the cavity 62.

In operation, the tie rod extension 64 engages the front head 70 so that the outward force 66 is countered by an inward force 68 to stabilize the tie rod nut 50 in the nut pocket 60. The extension 64 may not extend to a bottom of the cavity 62 so that during elongation of the tie rod 72, it will not be constrained to the front head 70.

Several mechanisms may be used to provide a second counterforce 69 that further restricts rotation of the tie rod nut 50. In one embodiment, a tolerance between the nut 50 at the back of the nut pocket 60 may be reduced to place the tie rod nut 50 in contact with the back of the nut pocket 60 so that the rotational movement of the tie rod nut 50 is further restricted by the counterforce at arrow 69.

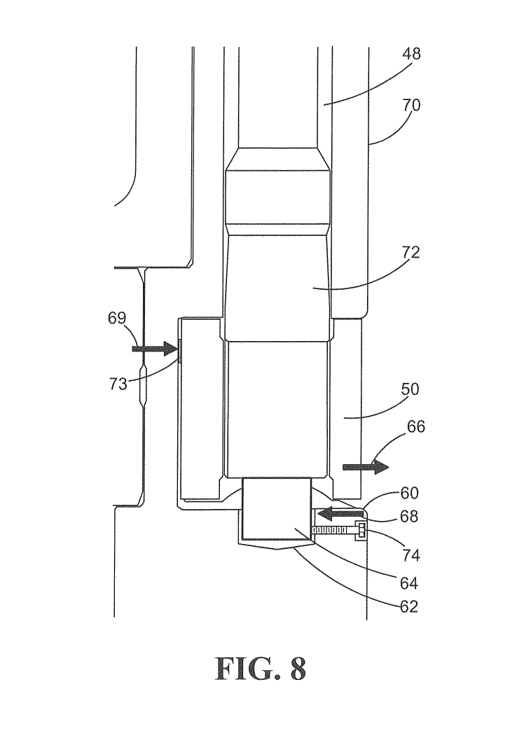

FIG. 8 illustrates additional embodiments for providing a second counterforce at the back of the tie rod nut 50. In one embodiment, a spacer 73 such as a disk may be placed to reduce the clearance at the top back of the tie rod nut 50 and provide the secondary counterforce 69. The spacer 73 may be embedded in the back wall of the nut pocket 60 or at a back of the tie rod nut 50. In place of, or in addition to these alternatives, a bolt 74 may be inserted at the cavity 62 to seat the tie rod nut 50 to the back of the nut pocket 60 to provide the counterforce 69. The bolt 74 may apply pressure to the tie rod extension 64, as shown, or may apply pressure to a bottom of the tie rod nut 86 when used with the embodiment of FIG. 12.

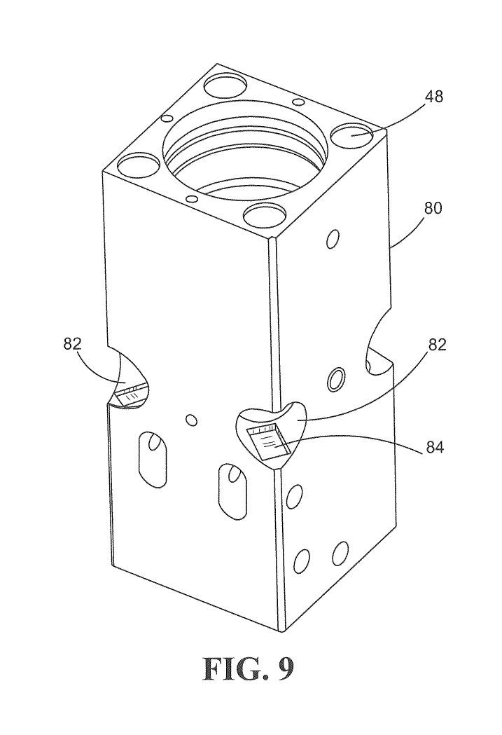

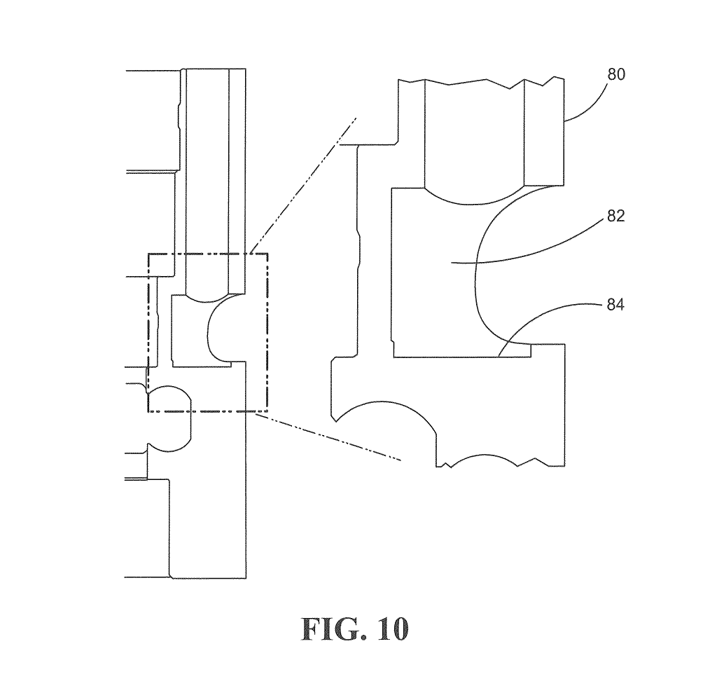

FIG. 9 illustrates a front head 80 adapted so that the nut pocket 82 has a cavity in the form of a slot 84. FIG. 10 is a cutaway view of the nut pocket 82 illustrating the slot 84.

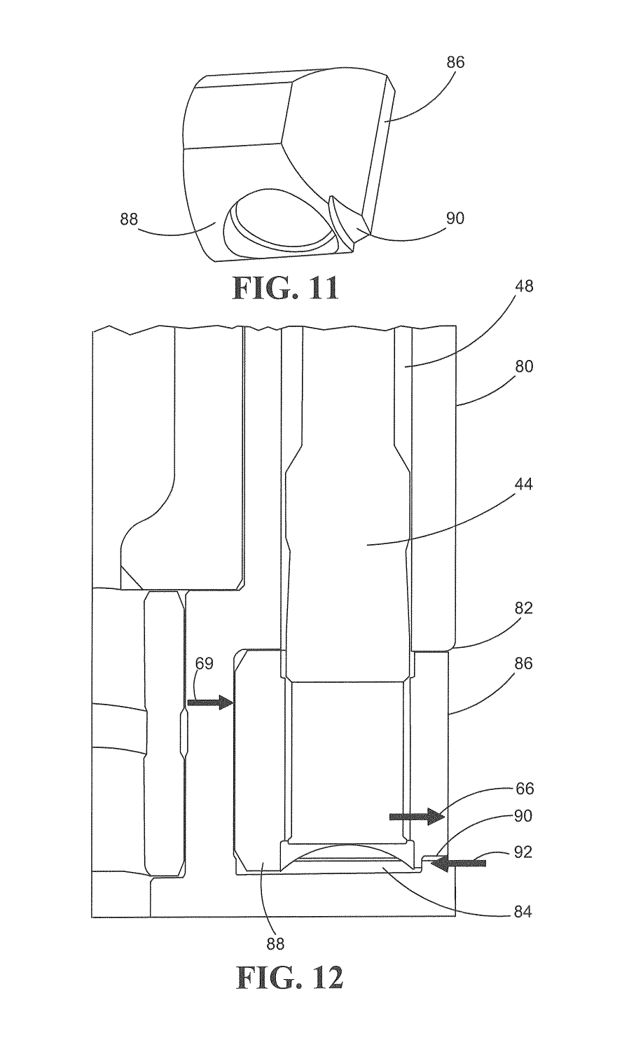

FIG. 11 is a perspective view of a tie rod nut 86 adapted to engage the slot 84 via a bottom face 88 of the tie rod nut 86 and a notch 90.

FIG. 12 is a cutaway view of the front head 80 of FIG. 9 with a tie rod 44 installed into a tie rod nut 86. As shown in FIGS. 9 and 10, a bottom face 88 of the tie rod nut 86 engages the slot 84 at notch 90. The tie rod nut 86 may be shaped to allow the tie rod nut 86 to be inserted at a 90 degree angle and rotated to the correct alignment so that its bottom engages in the slot 84. This allows the tie rod nut 86 to be sized to fit into the opening of the nut pocket 82 during assembly but to engage in the slot 84 when the inward counterforce is needed. Similar to FIG. 7, a horizontal outward force 66 is counteracted by an inward force 92 provided at an edge of the slot 84 against the notch 90, which, as above, acts to stabilize the tie rod nut 86 in the nut pocket 82 and limit bending of the tie rod 44.

As described above, the mechanisms to provide an additional counterforce 69 such as a reduced tolerance between the back of the nut 86 and the nut pocket 82, with or without a bolt 74, or a disk 73 may be provided.

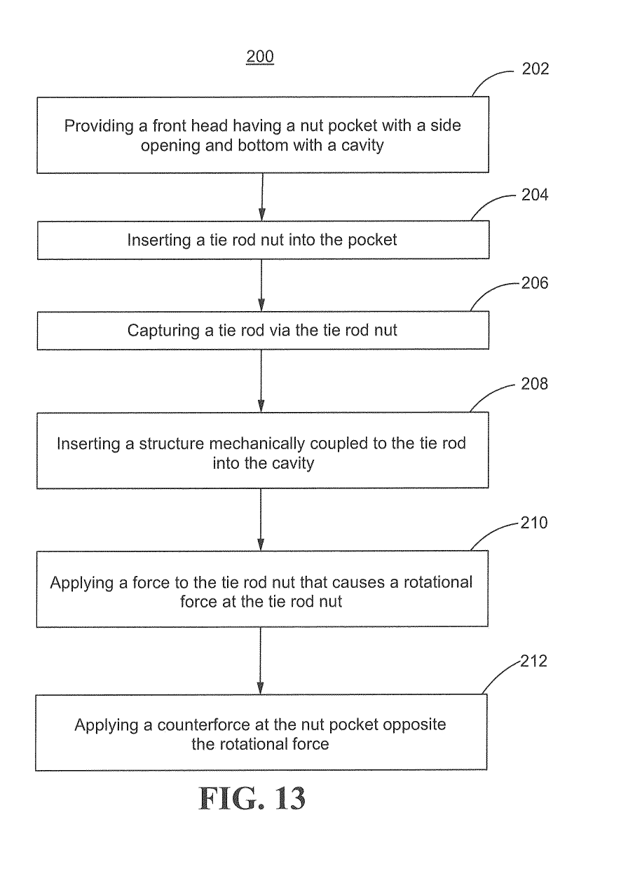

FIG. 13 is a flow chart of a method 200 of operating a hydraulic hammer 30, or more particularly, of assembling and using the hydraulic hammer 30. At a block 202, a front head 46 may be provided, the front head 46 having a nut pocket 60. The nut pocket 60 may have a side opening used to insert a tie rod nut 50 or 86. A top of the nut pocket 60 may be coupled, that is, open to a tie rod bore 38 at the top and a bottom of the nut pocket may have a cavity 62 or 84. The cavity 62 may be formed in a cylindrical shape and have any one of several bottom shapes including a flat bottom and a conically shaped recess bottom. In another embodiment, the cavity 84 may be in the form of a rectangular slot.

At a block 204, a tie rod nut 50, 86 may be inserted into the nut pocket.

At a block 206, a tie rod 44, 72 may be inserted into the tie rod nut 50, 86 via the tie rod bore 48. The tie rod 44, 72 may be captured by the tie rod nut 50, 86, for example, by threading the tie rod 44, 72 into the tie rod nut 50, 86.

At a block 208, a structure mechanically coupled to the tie rod 44, 72 may be inserted into the cavity 62, 84. In one embodiment, the structure may be an extension 64 of the tie rod 72 into the cavity 62. In another embodiment, the structure may be a bottom portion of the tie rod nut 86 having a notch 90 that engages the cavity 84 in the form of a slot.

At a block 210 a force may be applied to the tie rod nut 50, 86 that causes a rotational force at the tie rod nut 50, 86.

At a block 212, one or more counterforces may be applied opposite the rotational force at the tie rod nut 50, 86. As described above, a first counterforce 68, 92 may be applied at the bottom of the tie rod 50 nut via an extension 64 of the tie rod 44 or a structure of the tie rod nut 86 that engages a cavity 84 in the nut pocket 82. An additional counterforce 69 may be applied at the inside top of nut 50, 86 by causing contact between a back of the nut 50, 86 and a back of the nut pocket 60, 82, as described above. In this manner, damage such as bending of the tie rod can be minimized by preventing rotation of the tie rod nut 50, 86 in the nut pocket 60.

Although the drawings and description herein may be limited to the specific embodiments disclosed, those skilled in the art may appreciate that numerous variations may fall within the spirit and scope of the appended claims.

### INDUSTRIAL APPLICABILITY

In use, a tie rod 44 may be bent during normal use in a prior art manner because the open side of the nut pocket 60 and structural imbalance of the front head 36 at the nut pocket 60 may allow a tie rod nut 50 to rotate in the nut pocket 60 when the tie rod nut 50 is pulled up at the front head 36 by the tie rod 44. As described above, a counterforce 68 or 92 to an outward force 66 caused by the impending rotation of the nut 50, 86 keeps the nut 50, 86, and therefore the tie rod 44, in better alignment, reducing wear and stress. A second counterforce 69 may increase the counter-rotational effect on the tie rod nut 50, 86.

Either the tie rod extension 64 or the tie rod nut notch 90 engages the cavity 62, 84 formed in the bottom of the nut pocket 60 or 82 to provide the counterforces 68, 69 and/or 92.

Because tie rod bending can result in difficult repairs and extended downtime, the ability to maintain tie rod integrity benefits an owner/operator through improved efficiency, reduced replacement parts costs, and reduced repair costs. The cylindrical cavity 62 associated with nut pocket 60 or the slot cavity 84 in the bottom of the nut pocket 82 and corresponding structure either in the tie rod 72 or tie rod nut 86 provides an effective solution to tie rod bending without changing the mode of operation of the hydraulic hammer assembly 30 or changes to maintenance procedures.

Although several described embodiments of forming an improved nut pocket and its associated tie rod and tie rod nut have been disclosed herein, numerous other variations may fall within the spirit and scope of this disclosure.

What is claimed is:

1. A powered hammer assembly, comprising:
a front head having nut pockets, each nut pocket including a cavity;
a tie rod nut inserted into a nut pocket in a first direction;
a tie rod inserted into the front head and mechanically coupled to the tie rod nut; and
a structure mechanically coupled to the tie rod that engages the cavity and opposes motion of the tie rod nut in a direction opposite the first direction.

2. The powered hammer assembly of claim 1, wherein the cavity is a cylindrical recess.

3. The powered hammer assembly of claim 1, wherein the structure is a portion of the tie rod that extends through the tie rod nut.

4. The powered hammer assembly of claim 1, wherein the cavity is a slot.

5. The powered hammer assembly of claim 4, wherein the structure is a portion of the tie rod nut that engages the slot.

6. The powered hammer assembly of claim 1, wherein the front head has a rectangular parallelepiped shape and each of the nut pockets is formed at side corner of the front head.

7. A method of operating a hydraulic hammer comprising:
providing a front head having a nut pocket, the nut pocket having a side opening, a top of the nut pocket coupled to a tie rod bore and a bottom of the nut pocket having a cavity;
inserting a tie rod nut into the nut pocket;
inserting a tie rod into the tie rod bore;
capturing the tie rod via the tie rod nut; and
inserting a structure mechanically coupled to the tie rod into the cavity that limits movement of the tie rod nut in a direction of the side opening.

8. The method of claim 7, wherein the providing the front head comprises providing the front head having the cavity formed in a rectangular slot.

9. The method of claim 7, wherein providing the front head comprises providing the front head having the cavity formed in a cylindrical shape.

10. The method of claim 7, wherein inserting the structure into the cavity comprises inserting a portion of the tie rod that extends through the tie rod nut into the cavity.

11. The method of claim 7, wherein inserting the structure into the cavity comprises inserting a portion of the tie rod nut into the cavity.

12. The method of claim 7, further comprising maintaining a mechanical contact between a back of the nut and a back of the nut pocket that provides a force opposing rotation of the tie rod nut in the nut pocket.

13. The method of claim 12, wherein maintaining contact between the back of the nut and the back of the nut pocket comprises at least one of i) eliminating a clearance between the back of the nut and the back of the nut pocket, ii) providing a spacer at the back of the nut pocket to engage the back of the nut, and iii) forcing the structure toward a back of the cavity.

14. A mounting apparatus for a head of a powered hammer comprising:
a front head having four rectangular side faces;
four nut pockets, one nut pocket formed at each corner joining the four rectangular side faces;
four tie rod bores, a respective tie rod bore provided from a top of the front head to each nut pocket;
a cavity formed at a bottom of each nut pocket, each cavity opposite the respective tie rod bore in each of the four nut pockets;
a plurality of tie rod nuts, one tie rod nut inserted into each of the four nut pockets;
a plurality of tie rods, one tie rod inserted into a respective one of the four tie rod bores, each tie rod mechanically attached to a respective tie rod nut; and
a structure mechanically coupled to the tie rod that engages the cavity and opposes motion normal to a longitudinal axis of the tie rod.

15. The mounting apparatus of claim 14, wherein the structure is an extension of the tie rod that, when installed, extends beyond the tie rod nut and inserts into the cavity.

16. The mounting apparatus of claim 14, wherein the cavity is a slot and the tie rod nut has a bottom formed to engage the slot after installation in the nut pocket.

17. The mounting apparatus of claim 14, further comprising a bolt inserted at each corner below each nut pocket normal to the tie rod bore that penetrates the cavity to engage the structure.

18. The mounting apparatus of claim 17, wherein the bolt applies pressure to the structure that causes each tie rod nut to maintain contact between a back of the nut and a back of the nut pocket.

19. The mounting apparatus of claim 14, wherein a back of each nut is in physical contact with a back of its respective nut pocket.

20. The mounting apparatus of claim 19, further comprising a spacer that protrudes into a gap between the back of the nut and the back of the nut pocket to maintain the physical contact.
